(19) United States
(12) Patent Application Publication
(10) Pub. No.: US 2014/0052343 A1
(43) Pub. Date: Feb. 20, 2014

(54) Apparatus and method for storing and retrieving seating and instrument positions

(71) Applicant: Philip Ta-te Chen, Los Angeles, CA (US)

(72) Inventor: Philip Ta-te Chen, Los Angeles, CA (US)

(21) Appl. No.: 13/584,821

(22) Filed: Aug. 14, 2012

(51) Int. Cl. B60N 2/02

(52) U.S. Cl. 701/49

(57) ABSTRACT

A system for storing and retrieving seating and instrument positions based on user characteristics. The system stores seating and instrument positions for a variety of user heights or weights and retrieves an initial seating and instrument position setting based on the user's input. Preferably, the stored settings are ergonomic for the user's characteristics. A method for retrieving stored seating and instrument position is also taught.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The invention relates generally to an electronic system for storing and retrieving seating and instrument positions based on user characteristics.

Many of today's modern vehicles provide numerous options for electronically adjusting the seating and instrument positions. Basic seating adjustments in a passenger vehicle may include adjustments in the longitudinal direction (i.e., forward and back), the height of the seat, the angle of the seat bottom, and the angle of the seat backrest. Additional seating functionality may allow adjustments in the lumbar support, the backrest width, the shoulder support, the thigh support, and the height of the head restraint. In addition to seating adjustments, the modern vehicle may also allow electronic adjustment in instrument settings. For example, a passenger vehicle may provide for electronic adjustment to external rearview mirrors, steering wheel position and pedal position. These seating and instrument settings contribute to the ergonomics of operating the vehicle. Good ergonomic position benefits the user by increasing comfort and reducing fatigue and potential injury. In a passenger vehicle, ergonomic benefits can be recognized by both the driver of the vehicle and passengers.

Modern vehicles receive user inputs relating to seating and instrumentation, among other things, through various sources. Common sources include input through an interface such as an adjustment knob or through an electronic interface such as Audi's MMI system, BMW's iDrive system, and Mercedes's COMAND system. Vehicles can also receive pre-stored user inputs or information relating to pre-stored inputs through devices such as key fobs.

Modern vehicles also save and recall electronic settings. Many passenger vehicles store the seat and instrument positions settings described above. Those settings in a passenger vehicle can, for example, be associated with a particular user's key or remote control or be saved into vehicle memory (for example memory 1 or memory 2). Passenger vehicles can recall the stored settings and electronically adjust the seating position and instrument position to the stored settings. Vehicles generally arrive from the factory with a set seating and instrument position that may not be desirable for the individual user. Over time, that initial seating and instrument position settings are changed. This may occur frequently when there are multiple users of the vehicle. A problem arises when it is sometimes difficult for a vehicle user to set comfortable seating and instrument positions in vehicle.

### BRIEF SUMMARY OF THE INVENTION

The invention relates generally to a system for storing and retrieving seating and instrument positions based on user characteristics. A variety of seating adjustments are electronically adjustable and the stored seating position should be a preferably ergonomic seating arrangement for the user's height and weight. Likewise, a variety of instruments can be electronically positioned. The stored instrument positions should be a preferably arrangement for the user's characteristics.

One aspect of the invention is a system that stores and retrieves seating and instrument positions based on user characteristics such as height or weight. The user can then enter the user's height information to retrieve stored seating and instrument position settings. The stored seating and instrument position settings are preferably preset to achieve a comfortable operating position for an average person of that height. The user can then adjust this baseline setting to the user's individual preferences.

The stored seating and instrument position settings depend on numerous considerations and an ergonomic operating position may not always be possible. In a passenger vehicle, the settings should preferably seek to achieve an ergonomic driving position. Consideration should also preferably be given to whether the user can reach commonly-used features such as the audio system controls, the air conditioning control and the gear shifter on a manual transmission vehicle. Consideration should also preferably be given to allowing the user to have unobstructed views from the vehicle and also information displayed by the vehicle. However, as mentioned, an ergonomic driving position may not be possible due to various constraints such as the user space available within the vehicle to position the seat or the particular placement of instruments in the vehicle.

### BRIEF DESCRIPTION OF THE SEVERAL VIEWS OF THE DRAWING

FIG. 1 is a schematic of an electronic system for storing and retrieving seating and instrument positions according to the present invention.

FIG. 2 is a schematic of exemplary electronic entry with seating and instrument position information for a passenger vehicle.

### DETAILED DESCRIPTION OF THE INVENTION

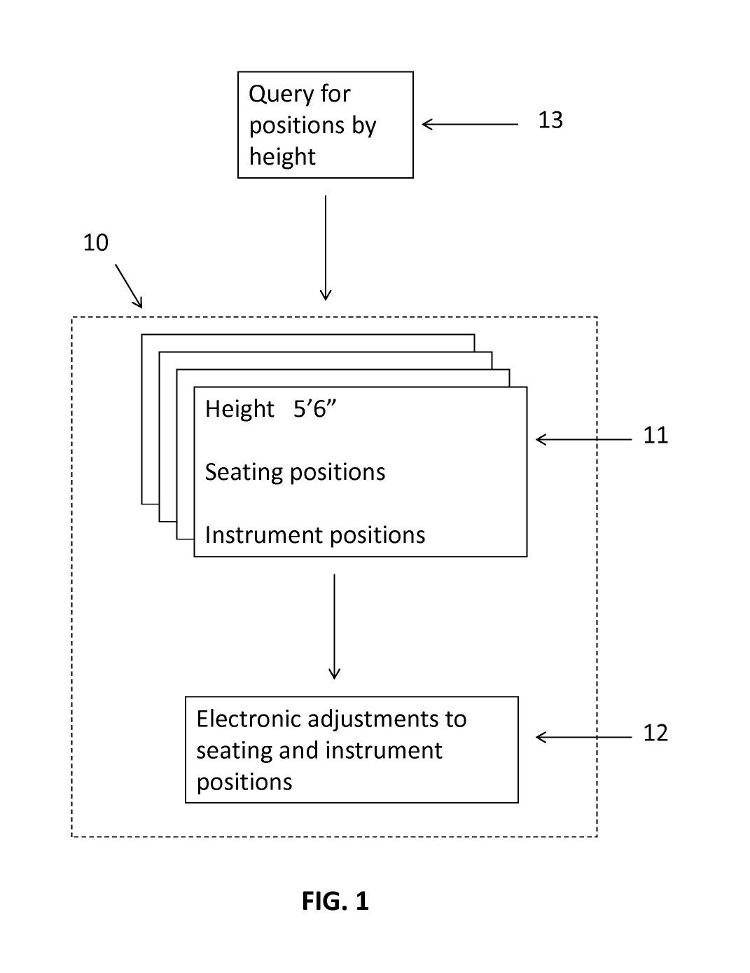

Referring to FIG. 1, an electronic system for storing and retrieving seating and instrument positions by the user characteristic according to the present invention is illustrated. The electronic system 10 is comprised of a storage device for storing seating and instruments positions 11 and an adjustment device for adjusting seating and instrument positions 12. In this exemplary system, the storage device 11 stores and retrieves seating and instrument positions by the user characteristic of height. When the system 10 receives input on user characteristics such as height 13, the storage device 11 retrieves seating and instrument positions for the received input and provides them to the adjustment device 12. The adjustment device 12 makes electronic adjustments to the seating and instrument positions based on information retrieved using the user characteristic input. The apparatuses for and methods of implementing stored position settings in the adjustment device 12 to electronically adjustable seats and instruments are well-known to those of skill in the art.

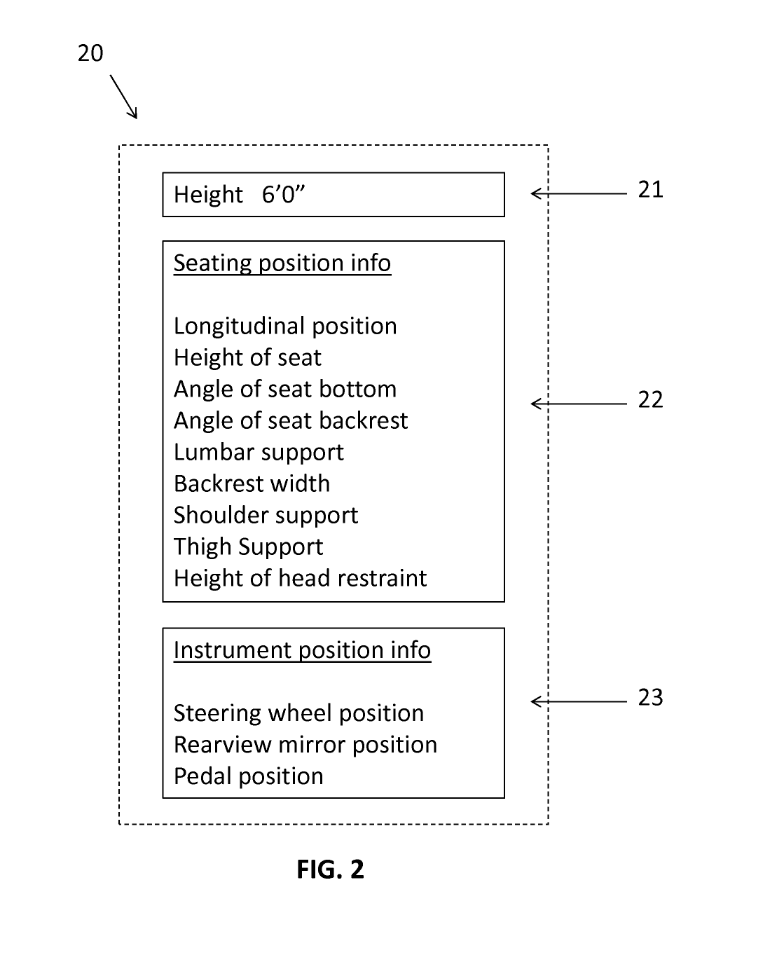

Referring to FIG. 2, an entry within the storage device 11 depicted in FIG. 1 for a passenger vehicle is illustrated. An illustrative electronic entry 20 within the storage device 11 may contain user characteristic information 21, seating position information 22 and instrument position information 23. User characteristic information 21 (such as height) is used to identify the seating position information 22 and instrument position information 23. The seating position information 22 may include the following adjustable positions for seating: longitudinal position (i.e., forward and back); height of the seat; angle of the seat bottom; angle of the seat backrest; lumbar support; backrest width; shoulder support; the thigh support; and height of the head restraint. The instrument position information 23 may include the following adjustable positions for instruments: steering wheel position; external rearview mirrors; and pedal position. The seating position information 22 and instrument position information 23 in the electronic entry 20 can be retrieved by user characteristic information 21 and provided to the adjustment device 12, which makes electronic adjustments to the seating and instrument positions in accordance with the information.

The seating position information 22 and instrument position information 23 will depend on numerous considerations, including space constraints, and an ergonomic position may not always be possible. In illustrative electronic entry 20 for a passenger vehicle, the settings should preferably seek to achieve an ergonomic driving position for the associated user characteristic of height. Consideration should also preferably be given to whether the user can reach commonly-used passenger vehicle features such as the audio system controls, the air conditioning control and the gear shifter on a manual transmission vehicle. Consideration should also preferably be given to allowing the user to have unobstructed views from the vehicle and also information displayed by the vehicle.

The foregoing disclosure is exemplary. Modifications and variations will be obvious to one skilled in the art. The foregoing disclosure is intended to enable one skilled to practice the invention and is not limited thereby but is limited only by the spirit and scope of the claims.

1. An electronic system for storing seating positions by a user characteristic and adjusting the seating positions based on an input user characteristic.

2. The system of claim 1, where the user characteristic is height.

3. The system of claim 1, where the user characteristic is weight.

4. An electronic system for storing instrument positions by a user characteristic and adjusting the instrument positions based on an input user characteristic.

5. The system of claim 4, where a user characteristic is height.

6. A method for applying stored seating positions based on a user characteristic comprising
(a) receiving an input from the user comprising a user characteristic;
(b) retrieving stored information on seating positions from an electronic system based on the input; and
(c) adjusting the seating positions based on the retrieved information.

7. The method of claim 6, where the user characteristic is height.

8. The system of claim 1, where the seating positions are ergonomic seating positions for a user characteristic.

9. The system of claim 4, where the instrument positions are ergonomic instrument positions for a user characteristic.

10. The method of claim 6, where the seating positions are ergonomic seating positions for a user characteristic.
